(19) United States
(12) Patent Application Publication
(10) Pub. No.: US 2017/0177168 A1
(43) Pub. Date: Jun. 22, 2017

(54) Methods, Systems, and Computer Readable Media for Application Independent Digital Watermarking

(71) Applicant: Saudi Arabian Oil Company, Dhahran (SA)

(72) Inventors: Abduladhim A. Abudib, Dhahran (SA); Hussain A. Rasheed, Dhahran (SA)

(21) Appl. No.: 14/978,306

(22) Filed: Dec. 22, 2015

(51) Int. Cl. G06F 3/0481; H04L 29/08

(52) U.S. Cl. CPC G06F 3/0481; H04L 67/10

(57) ABSTRACT

Methods, systems, and computer readable media for displaying a digital watermark on computer screens in a company or an organization. The application runs at an operating system level and shows current user ID as a watermark on all applications, windows, tools, etc. Optional displayed watermark elements could include the IP address of the user, date, time, and machine name. Further, the screen adapts to the size and resolution of the screen. The screen may be divided into multiple cells, with the watermark moving around in each cell to avoid screen burn in. Additionally, a separate window could be created for each screen attached to the computer. The application can be used to broadcast a message to all screens in the company or organization.

### BACKGROUND OF THE INVENTION

1. Field

The field of the invention relates generally to watermarking in a computer environment. More specifically the present disclosure relates to methods, systems, and computer readable media for application independent digital watermarking.

2. Description of the Related Art

With electronic communication becoming the way of life, it has become increasingly important for corporations and institutions to protect sensitive information on their hard assets, including computers and smartphones. Data leakage prevention and intellectual asset protection have become a challenge for some companies. While watermarking important data does provide some form of protection, users are still able to capture sensitive information using smartphones or cameras or using the print-screen function in an operating system and able to transmit the captured sensitive information via cellular networks.

Attempts to improve data leakage prevention and intellectual asset protection have been made in the past; however, they are not completely successful. For example, the Windows® Aero® theme enables a user to bypass a watermark by hovering over the application or document in the task bar. This also allows the user to print-screen the document or application without having the watermark, essentially disabling the Aero® theme.

The above discussed methodologies do not solve the issue of the user being able to use a camera or a phone to take a picture of critical information, or using the screen-print function and printing or emailing the image. Moreover, these methodologies cannot be used to trace the source of data leakage and they are limited only to certain types of videos or images.

### SUMMARY

As disclosed, the present invention includes systems, methods, and computer readable media for generating an application independent digital watermark, which always shows on top of a user terminal and cannot be circumvent by taking images using smartphones or cameras or by using the print screen function in an operating system.

One example embodiment is a non-transitory computer-readable medium including instructions stored thereon, which when executed by one or more processors of a computing device, cause the computing device to perform operations including determining that a first screen is connected to the computing device, generating a first window based at least in part on a screen resolution or screen size of the first screen, generating a stack panel including a first label and a second label, wherein the first label and second label are based at least in part on a unique network-related identifier, and displaying, on the first window, the stack panel including the first label and the second label. The instructions further cause the computing device to perform operations including generating a plurality of cells within the first window, and displaying, on the first window, the stack panel in each of the plurality of cells.

The first label may include a first color, and the second label includes a second color. The unique network-related identifier may include a user identification (ID), a network identification (ID), an internet protocol (IP) address, date, time, and/or machine name. The instructions further cause the computing device to perform operations including receiving a first alert message from a networked computer, generating a marquee text based at least in part on the first alert message, and displaying the marquee text on the first window. The instructions further cause the computing device to perform operations including determining that a second screen is connected to the computing device, and generating a second window based at least in part on a screen resolution or screen size of the for a second screen. The instructions further cause the computing device to perform operations including generating the first window or second window with a transparent background. The instructions further cause the computing device to perform operations including generating the first label with a vertical or horizontal orientation. The instructions further cause the computing device to perform operations including determining a process privilege of the operations or a data registry to prevent a user from terminating the operations. The instructions further cause the computing device to perform operations including causing to move the stack panel within the plurality of cells based at least in part on a predetermined time interval provided in a predetermined configuration. The instructions further cause the computing device to perform operations including determining that the first window is not a top-most window, and causing to move the first window to the top-most window. The instructions further cause the computing device to perform operations including determining time of a last activity is greater than a predetermined time, and causing to move the first window to the top-most window.

One example embodiment is a method for digital watermarking, including determining, by a processor in a computing device including at least one memory, that a first screen is connected to the computing device, generating, by the processor, a first window based at least in part on a screen resolution or screen size of the first screen, generating, by the processor, a stack panel including a first watermark and a second watermark, wherein the first watermark and second watermark are based at least in part on a unique network-related identifier, and displaying, on the first window, the stack panel including the first watermark and the second watermark. The method also includes generating, by the processor, a plurality of cells within the first window, and displaying, on the first window, the stack panel in each of the plurality of cells.

The first watermark may include a first color, and the second watermark includes a second color. The unique network-related identifier may include a user identification (ID), a network identification (ID), an internet protocol (IP) address, date, time, and/or machine name. The method may also include receiving, by the processor, a first alert message from a networked computer, generating, by the processor, a marquee text based at least in part on the first alert message, and displaying the marquee text on the first window. The method may also include determining, by the processor, that a second screen is connected to the computing device, and generating, by the processor, a second window based at least in part on a screen resolution or screen size of the for a second screen. The method may also include generating, by the processor, the first window or second window with a transparent background. The method may also include generating, by the processor, the first watermark with a vertical or horizontal orientation. The method may also include determining, by the processor, a process privilege of the method or a data registry to prevent a user from terminating the method. The method may also include causing to move the stack panel within the plurality of cells based at least in part on a predetermined time interval provided in a predetermined configuration. The method may also include determining, by the processor, that the first window is not a top-most window, and causing to move the first window to the top-most window. The method may also include determining, by the processor, time of a last activity is greater than a predetermined time, and causing to move the first window to the top-most window.

One example embodiment is an apparatus for digital watermarking, including at least one memory device having programmed instructions, and at least one processor functionally coupled to the at least one memory device and configured to execute the programmed instructions, and in response to execution of the programmed instructions, further configured to determine that a first screen is connected to a computer, generate a first window based at least in part on a screen resolution or screen size of the first screen, generate a first watermark based at least in part on a unique network-related identifier, and display, on the first window, the first watermark. The processor may be further configured to generate a second watermark based at least in part on a unique network-related identifier, and display, on the first window, the second watermark. The processor may be further configured to generate a plurality of cells within the first window, and display, on the first window, the first watermark in each of the plurality of cells.

The first watermark may include a first color, and the second watermark includes a second color. The unique network-related identifier may include a user identification (ID), a network identification (ID), an internet protocol (IP) address, date, time, and/or machine name. The processor may be further configured to receive a first alert message from a networked computer, generate a marquee text based at least in part on the first alert message, and display the marquee text on the first window. The processor may be further configured to determine that a second screen is connected to the computing device, and generate a second window based at least in part on a screen resolution or screen size of the for a second screen. The processor may be further configured to generate the first window or second window with a transparent background. The processor may be further configured to generate the first watermark with a vertical or horizontal orientation. The processor may be further configured to determine a process privilege or a data registry to prevent a user from terminating one or more modules. The processor may be further configured to cause to move the first watermark within the plurality of cells based at least in part on a predetermined time interval provided in a predetermined configuration. The processor may be further configured to determine that the first window is not a top-most window, and cause to move the first window to the top-most window. The processor may be further configured to determine a time of a last activity is greater than a predetermined time, and cause to move the first window to the top-most window.

### BRIEF DESCRIPTION OF THE DRAWINGS

All aspects and features of certain example embodiments of the present disclosure will be more apparent from the following description taken in conjunction with the accompanying drawings, in which:

FIG. 1 illustrates an example system for providing application independent digital watermarking, according to one or more example embodiments of the present disclosure.

FIG. 2 illustrates an example system including application independent digital watermarking, according to one or more example embodiments of the present disclosure.

FIG. 3 illustrates an example system including application independent digital watermarking, according to one or more example embodiments of the present disclosure.

FIG. 4 illustrates an example system including application independent digital watermarking, according to one or more example embodiments of the present disclosure.

FIG. 5 is a flow chart illustrating example operations in a method for application independent digital watermarking, according to one or more example embodiments of the present disclosure.

FIG. 6 is a flow chart illustrating example operations in a method for application independent digital watermarking, according to one or more example embodiments of the present disclosure.

FIG. 7 illustrates an example apparatus on which one or more methods, according to one or more example embodiments of the present disclosure, may be executed.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Details of one or more implementations are set forth in the accompanying drawings and in the description below. Further embodiments, features, and aspects will become apparent from the description, the drawings, and the claims. Embodiments set forth in the claims encompass all available equivalents of those claims.

### DETAILED DESCRIPTION

The Specification, which includes the Summary, Brief Description of the Drawings and the Detailed Description, and the appended Claims refer to particular features (including process or method steps) of the disclosure. Those of skill in the art understand that the invention includes all possible combinations and uses of particular features described in the Specification. Those of skill in the art understand that the disclosure is not limited to or by the description of embodiments given in the Specification.

Those of skill in the art also understand that the terminology used for describing particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a,” “an,” and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced. The verb “couple” and its conjugated forms means to complete any type of required junction, including electrical, mechanical or fluid, to form a singular object from two or more previously non-joined objects. If a first device couples to a second device, the connection can occur either directly or through a common connector. “Optionally” and its various forms means that the subsequently described event or circumstance may or may not occur. The description includes instances where the event or circumstance occurs and instances where it does not occur.

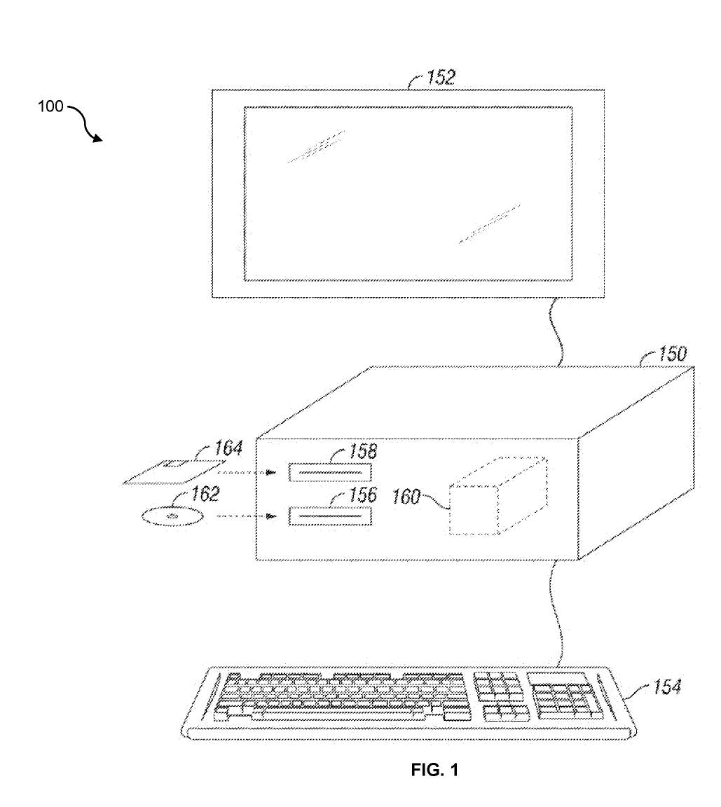

Turning now to the figures, FIG. 1 illustrates an example system 100 for providing application independent digital watermarking, according to one or more example embodiments of the present disclosure. The system 100 may include a computer 150 which may include one or more processors (not shown) and one or more memory devices or computer readable media 160, 162, 164. In one example embodiment, the invention relates to computer programs or computer code stored in computer readable media 160, 162, 164. The computer programs can be stored on, e.g., a computer readable medium, such as a floppy disk 164, CD-ROM 162 or a magnetic (or other type) hard drive 160 forming part of a general purpose programmable computer 150. The computer 150, as known in the art, includes one or more processors, a user input device such as a keyboard 154 and a user display 152 such as a flat panel LCD display. According to this aspect of the invention, the computer readable medium includes logic operable to cause the computer to execute acts as set forth below and explained with respect to the following figures.

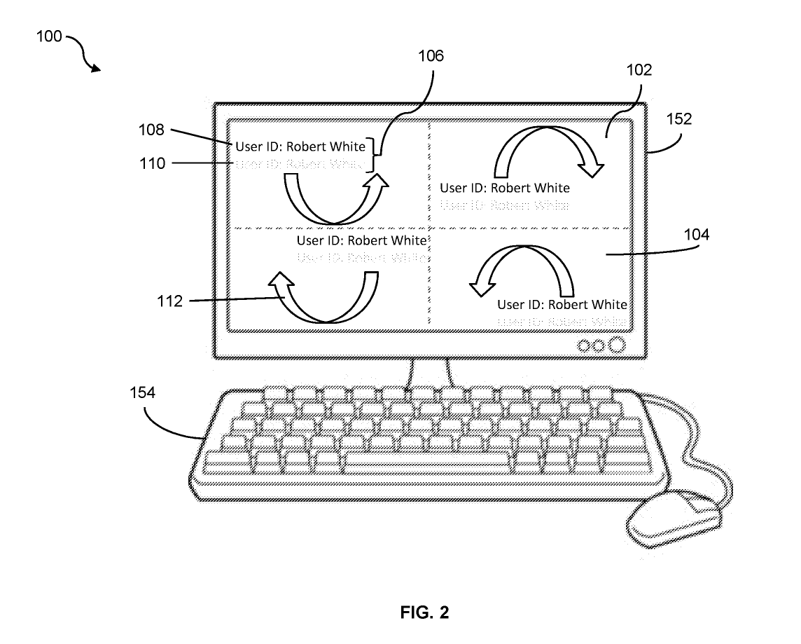

FIG. 2 illustrates an example system or computing device 100 where an example user “Robert White” has logged onto the system 100. One example embodiment is a non-transitory computer-readable medium including instructions stored thereon, which when executed by one or more processors of the computing device 100, cause the computing device 100 to perform operations including determining that a first screen 152 is connected to the computing device 100. When the computing device 100 detects that a screen 152 is connected, it generates a first window 102 based at least in part on a screen resolution or screen size of the screen 152. The system then generates a stack panel 106 including a first label or watermark 108 and a second label or watermark 110. The first label 108 and second label 110 may be based at least in part on a unique network-related identifier. Upon generating the stack panel 106, the system displays, on the first window 102, the stack panel 106 including the first label 108 and the second label 110. In order to cover the entire width and height of the screen 152, the system generates a plurality of cells 104 within the first window 102, and displays the stack panel 106 in each of the plurality of cells 104. Although the stack panel 106 is illustrated in its entirety in FIG. 2, the system 100 may only generate the first label or watermark 108 or only the second label or water 110 for display on screen 152.

The first label 108 may include a first color, and the second label 110 may include a second color, which may be similar to or different from the first color. In an illustrative embodiment, the first label 108 may be produced in black color and the second label 110 may be produced in white. The unique network-related identifier may include a user identification (ID), a network identification (ID), an internet protocol (IP) address, date, time, and/or machine name.

In one embodiment, the first window 102 may be generated with a transparent background, such that other windows or applications are still visible to a user with the stack panel 106 overlapped on them in various places. In another embodiment, the system may generate the first label 108 and/or the second label 110 with a vertical or horizontal orientation. The system 100 may also cause to move the stack panel 106 within the plurality of cells 104 based at least in part on a predetermined time interval provided in a predetermined configuration.

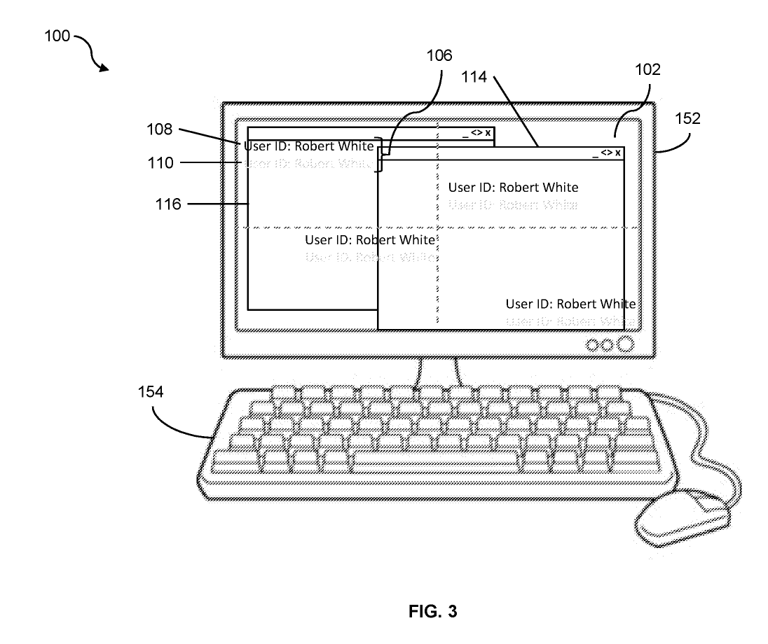

Illustrated in FIG. 3 is one example embodiment of the system 100 where multiple windows or applications 114, 116 are displayed on the screen 152. In such an instance, if the system determines that the first window 102 is not a top-most window, then the system causes to move the first window 102 including the stack panel 106 to the top-most window. In an additional or alternate embodiment, the system may determine the time of a last activity is greater than a predetermined time, and cause to move the first window 102 including the stack panel 106 to the top-most window. This may be specifically important in operating systems where screensavers may be enabled. In such systems, the present embodiment overrides the screensaver by moving the first window 102 including the stack panel 106 to the top-most window. In one example embodiment, the system may determine or modify a process privilege of one or more modules or a data registry to prevent a user from terminating the watermarking process.

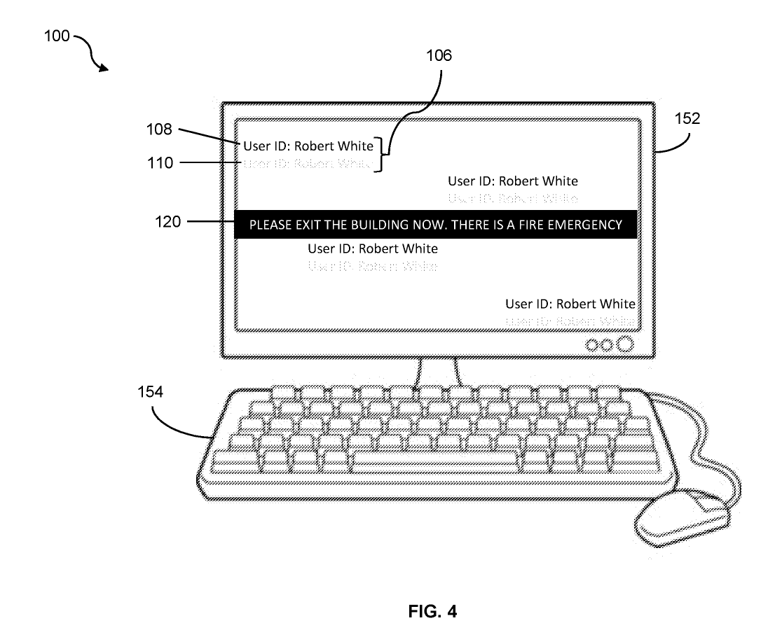

Illustrated in FIG. 4 is one example embodiment of the system 100 where a message 120 may be received from another networked computer. Upon receiving the message, which may be an alert message or an emergency message, the system may generate a marquee text based at least in part on the message 120, and display the marquee text on the first window 102. In an example embodiment, if a second screen is connected to the computing device 100, the system may generate a second window based at least in part on a screen resolution or screen size of the for a second screen.

It should be noted that the example computational environment shown in FIGS. 1-4 is only illustrative and is not intended to suggest or otherwise convey any limitation as to the scope of use or functionality of such computational environments' architecture. In addition, the computational environment should not be interpreted as having any dependency or requirement relating to any one or combination of components illustrated in this example computational environment. The computational environment represents an example of a software implementation of the various aspects or features of the disclosure in which the processing or execution of operations described in connection with performing a maintenance action in accordance with this disclosure, can be performed in response to execution of one or more software components at the computing device. A software component can be embodied in or can comprise one or more computer-accessible instructions, e.g., computer-readable and/or computer-executable instructions. At least a portion of the computer-accessible instructions can embody one or more of the example techniques disclosed herein. For instance, to embody one such method, at least the portion of the computer-accessible instructions can be persisted (e.g., stored, made available, or stored and made available) in a computer storage non-transitory medium and executed by a processor. The one or more computer-accessible instructions that embody a software component can be assembled into one or more program modules, for example, that can be compiled, linked, and/or executed at the computing device or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device or functionally coupled thereto.

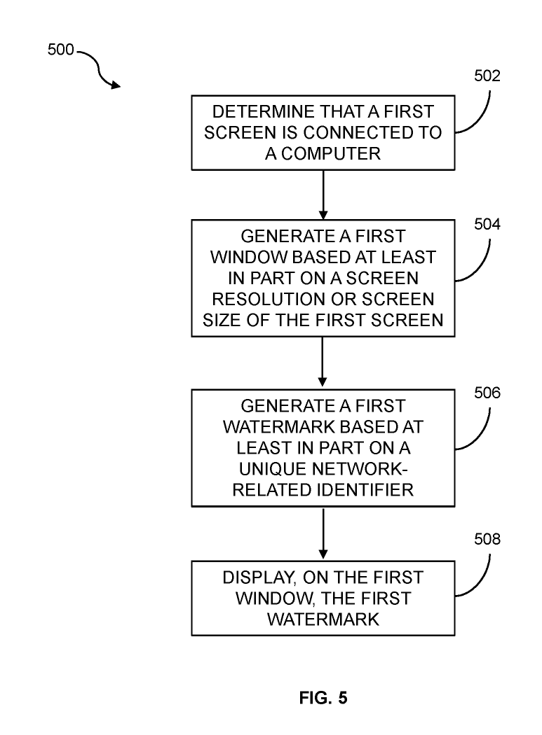

FIG. 5 illustrates example operations in method 500 for providing an application independent digital watermarking, according to one or more example embodiments of the present disclosure. Method 500 may include determining, by an apparatus including at least one memory device having programmed instructions, and at least one processor functionally coupled to the at least one memory device and configured to execute the programmed instructions, that a first screen is connected to a computer at operation 502. Method 500 may also include generating, by the apparatus, a first window based at least in part on a screen resolution or screen size of the first screen at operation 504. At operation 506, the apparatus may generate a first watermark based at least in part on a unique network-related identifier, and at operation 508 the apparatus may display, on the first window, the first watermark.

In one example embodiment, the apparatus may be further configured to generate a second watermark based at least in part on a unique network-related identifier, and display, on the first window, the second watermark. The processor may be further configured to generate a plurality of cells within the first window, and display, on the first window, the first watermark in each of the plurality of cells.

For purposes of simplicity of explanation, the example method disclosed herein is presented and described as a series of blocks (with each block representing an action or an operation in a method, for example). However, it is to be understood and appreciated that the disclosed method is not limited by the order of blocks and associated actions or operations, as some blocks may occur in different orders and/or concurrently with other blocks from those that are shown and described herein. For example, the various methods (or processes or techniques) in accordance with this disclosure can be alternatively represented as a series of interrelated states or events, such as in a state diagram. Furthermore, not all illustrated blocks, and associated action(s), may be required to implement a method in accordance with one or more aspects of the disclosure. Further yet, two or more of the disclosed methods or processes can be implemented in combination with each other, to accomplish one or more features or advantages described herein.

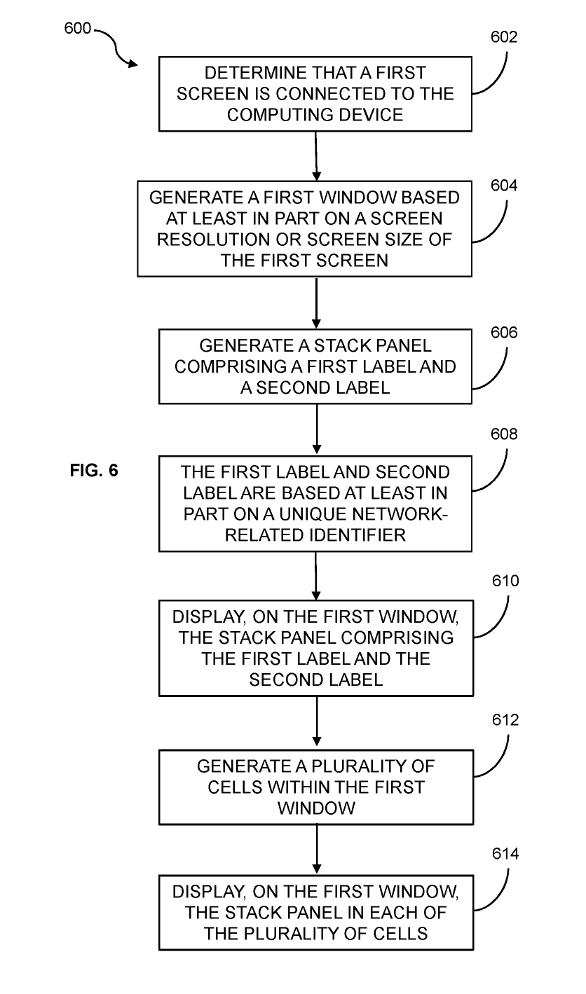

FIG. 6 illustrates example operations in a method 600 for providing application independent digital watermarking, according to one or more example embodiments. At operation 602, the method 600 includes determining, by a processor in a computing device including at least one memory, that a first screen is connected to the computing device. At operation 604, the method includes, generating, by the processor, a first window based at least in part on a screen resolution or screen size of the first screen. At operation 606, the method includes generating, by the processor, a stack panel including a first watermark and a second watermark. At operation 608, the first watermark and second watermark may be produced based at least in part on a unique network-related identifier. At operation 610, the method includes displaying, on the first window, the stack panel including the first watermark and the second watermark. The method 600 also includes generating, by the processor, a plurality of cells within the first window at operation 612. At operation 614, the method includes displaying, on the first window, the stack panel in each of the plurality of cells.

In one example embodiment, the first watermark may include a first color, and the second watermark includes a second color. The unique network-related identifier may include a user identification (ID), a network identification (ID), an internet protocol (IP) address, date, time, and/or machine name.

It should be appreciated that the techniques of the disclosure can be retained on an article of manufacture, or computer-readable medium, to permit or facilitate transporting and transferring such methods to a computing device (e.g., a desktop computer; a mobile computer, such as a tablet, or a smartphone; a gaming console, a mobile telephone; a blade computer; a programmable logic controller, and the like) for execution, and thus implementation, by a processor of the computing device or for storage in a memory thereof or functionally coupled thereto. In one aspect, one or more processors, such as processor(s) that implement (e.g., execute) one or more of the disclosed techniques, can be employed to execute code instructions retained in a memory, or any computer- or machine-readable medium, to implement the one or more methods. The code instructions can provide a computer-executable or machine-executable framework to implement the techniques described herein.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

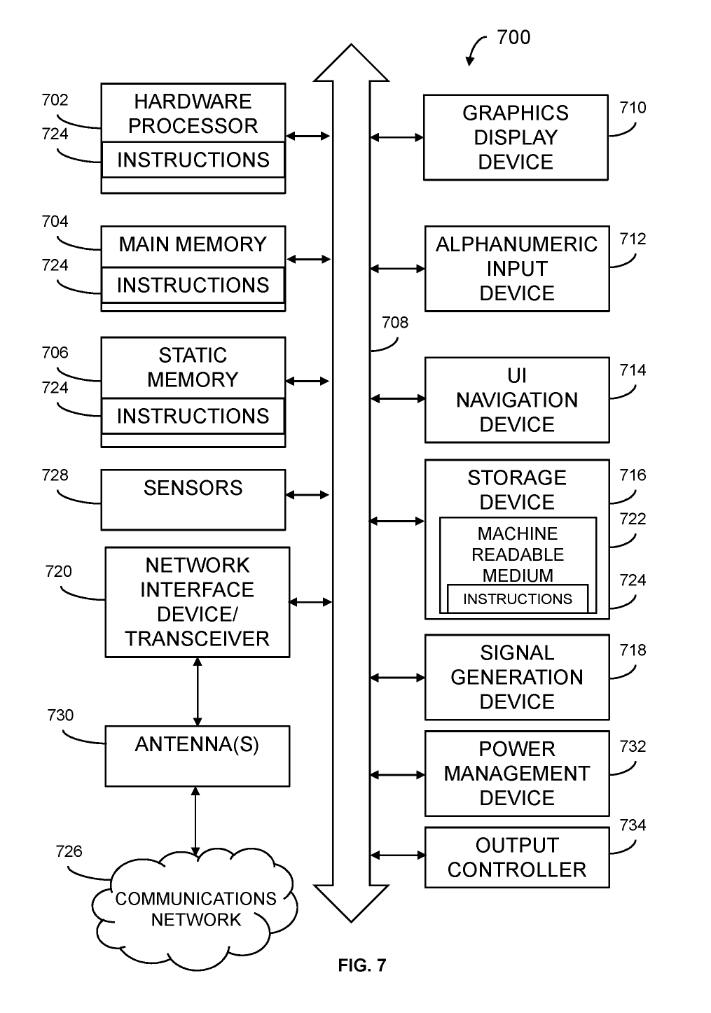

FIG. 7 illustrates a block diagram of an example of a machine 700 or system upon which any one or more of the methods or techniques discussed above may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712 and UI navigation device 714 may be a touch screen display. The machine 700 may additionally include a storage device (i.e., drive unit) 716, a signal generation device 718 (e.g., a speaker), a network interface device/transceiver 720 coupled to antenna(s) 730, and one or more sensors 728, such as a global positioning system (GPS) sensor, compass, accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium includes a machine readable medium with a plurality of particles having resting mass. Specific examples of massed machine readable media may include: non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magnetooptical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input singleoutput (MISO) techniques. The term “transmission medium” shall be taken to include any intangible medium that is capable of storing, encoding or carrying instructions for execution by the machine 700, and includes digital or analog communications signals or other intangible media to facilitate communication of such software.

As illustrated above, the apparatus 700 may include at least one memory device 704, 706 having programmed instructions 724, and at least one processor 702 functionally coupled to the at least one memory device 704, 706 and configured to execute the programmed instructions 724, and in response to execution of the programmed instructions, further configured to determine that a first screen is connected to a computer, generate a first window based at least in part on a screen resolution or screen size of the first screen, generate a first watermark based at least in part on a unique network-related identifier, and display, on the first window, the first watermark. The processor 702 may be further configured to generate a second watermark based at least in part on a unique network-related identifier, and display, on the first window, the second watermark. The processor may be further configured to generate a plurality of cells within the first window, and display, on the first window, the first watermark in each of the plurality of cells.

The processor may be further configured to receive a first alert message from a networked computer, generate a marquee text based at least in part on the first alert message, and display the marquee text on the first window. The processor may be further configured to determine that a second screen is connected to the computing device, and generate a second window based at least in part on a screen resolution or screen size of the for a second screen. The processor may be further configured to generate the first window or second window with a transparent background. The processor may be further configured to generate the first watermark with a vertical or horizontal orientation. The processor may be further configured to determine a process privilege or a data registry to prevent a user from terminating one or more modules. The processor may be further configured to cause to move the first watermark within the plurality of cells based at least in part on a predetermined time interval provided in a predetermined configuration. The processor may be further configured to determine that the first window is not a top-most window, and cause to move the first window to the top-most window. The processor may be further configured to determine a time of a last activity is greater than a predetermined time, and cause to move the first window to the top-most window.

While there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit of the invention. Moreover, it is expressly intended that all combinations of those elements and/or method operations, which perform substantially the same function in substantially the same way to achieve the same results, are within the scope of the disclosure. Moreover, it should be recognized that structures and/or elements and/or method operations shown and/or described in connection with any disclosed form or embodiment of the disclosure may be incorporated in any other disclosed or described or suggested form or embodiment as a general matter of design choice. It is the intention, therefore, to be limited only as indicated by the scope of the claims appended hereto.

What is claimed is:

1. A non-transitory computer-readable medium including instructions stored thereon, which when executed by one or more processors of a computing device, cause the computing device to perform operations comprising:
determining that a first screen is connected to the computing device;
generating a first window based at least in part on a screen resolution or screen size of the first screen;
generating a stack panel comprising a first label and a second label, wherein the first label and second label are based at least in part on a unique network-related identifier; and
displaying, on the first window, the stack panel comprising the first label and the second label.

2. The non-transitory computer-readable medium of claim 1, wherein the instructions further cause the computing device to perform operations comprising:
generating a plurality of cells within the first window; and
displaying, on the first window, the stack panel in each of the plurality of cells.

3. The non-transitory computer-readable medium of claim 1, wherein the first label comprises a first color, and the second label comprises a second color.

4. The non-transitory computer-readable medium of claim 1, wherein the unique network-related identifier comprises a user identification (ID), a network identification (ID), an internet protocol (IP) address, date, time, and/or machine name.

5. The non-transitory computer-readable medium of claim 1, wherein the instructions further cause the computing device to perform operations comprising:
receiving a first alert message from a networked computer;
generating a marquee text based at least in part on the first alert message; and
displaying the marquee text on the first window.

6. The non-transitory computer-readable medium of claim 1, wherein the instructions further cause the computing device to perform operations comprising:
determining that a second screen is connected to the computing device; and
generating a second window based at least in part on a screen resolution or screen size of the for a second screen.

7. The non-transitory computer-readable medium of claim 6, wherein the instructions further cause the computing device to perform operations comprising:
generating the first window or second window with a transparent background.

8. The non-transitory computer-readable medium of claim 1, wherein the instructions further cause the computing device to perform operations comprising:
generating the first label with a vertical or horizontal orientation.

9. The non-transitory computer-readable medium of claim 1, wherein the instructions further cause the computing device to perform operations comprising:
determining a process privilege of the operations or a data registry to prevent a user from terminating the operations.

10. The non-transitory computer-readable medium of claim 2, wherein the instructions further cause the computing device to perform operations comprising:
causing to move the stack panel within the plurality of cells based at least in part on a predetermined time interval provided in a predetermined configuration.

11. The non-transitory computer-readable medium of claim 1, wherein the instructions further cause the computing device to perform operations comprising:
determining that the first window is not a top-most window; and
causing to move the first window to the top-most window.

12. The non-transitory computer-readable medium of claim 1, wherein the instructions further cause the computing device to perform operations comprising:
determining time of a last activity is greater than a predetermined time; and
causing to move the first window to the top-most window.

13. A method for digital watermarking, comprising:
determining, by a processor in a computing device comprising at least one memory, that a first screen is connected to the computing device;
generating, by the processor, a first window based at least in part on a screen resolution or screen size of the first screen;
generating, by the processor, a stack panel comprising a first watermark and a second watermark, wherein the first watermark and second watermark are based at least in part on a unique network-related identifier; and
displaying, on the first window, the stack panel comprising the first watermark and the second watermark.

14. The method of claim 13, further comprising:
generating, by the processor, a plurality of cells within the first window; and
displaying, on the first window, the stack panel in each of the plurality of cells.

15. The method of claim 13, wherein the first watermark comprises a first color, and the second watermark comprises a second color.

16. The method of claim 13, wherein the unique network-related identifier comprises a user identification (ID), a network identification (ID), an internet protocol (IP) address, date, time, and/or machine name.

17. The method of claim 13, further comprising:
receiving, by the processor, a first alert message from a networked computer;
generating, by the processor, a marquee text based at least in part on the first alert message; and
displaying the marquee text on the first window.

18. The method of claim 13, further comprising:
determining, by the processor, that a second screen is connected to the computing device; and
generating, by the processor, a second window based at least in part on a screen resolution or screen size of the for a second screen.

19. The method of claim 18, further comprising:
generating, by the processor, the first window or second window with a transparent background.

20. The method of claim 13, further comprising:
generating, by the processor, the first watermark with a vertical or horizontal orientation.

21. The method of claim 13, further comprising:
determining, by the processor, a process privilege of the method or a data registry to prevent a user from terminating the method.

22. The method of claim 14, further comprising:
causing to move the stack panel within the plurality of cells based at least in part on a predetermined time interval provided in a predetermined configuration.

23. The method of claim 13, further comprising:
determining, by the processor, that the first window is not a top-most window; and
causing to move the first window to the top-most window.

24. The method of claim 13, further comprising:
determining, by the processor, time of a last activity is greater than a predetermined time; and
causing to move the first window to the top-most window.

25. An apparatus for digital watermarking, comprising:
at least one memory device having programmed instructions; and
at least one processor functionally coupled to the at least one memory device and configured to execute the programmed instructions, and in response to execution of the programmed instructions, further configured to:
determine that a first screen is connected to a computer;
generate a first window based at least in part on a screen resolution or screen size of the first screen;
generate a first watermark based at least in part on a unique network-related identifier; and
display, on the first window, the first watermark.

26. The apparatus of claim 25, wherein the processor is further configured to:
generate a second watermark based at least in part on a unique network-related identifier; and
display, on the first window, the second watermark.

27. The apparatus of claim 25, wherein the processor is further configured to:
generate a plurality of cells within the first window; and
display, on the first window, the first watermark in each of the plurality of cells.

28. The apparatus of claim 25, wherein the first watermark comprises a first color, and the second watermark comprises a second color.

29. The apparatus of claim 25, wherein the unique network-related identifier comprises a user identification (ID), a network identification (ID), an internet protocol (IP) address, date, time, and/or machine name.

30. The apparatus of claim 25, wherein the processor is further configured to:
receive a first alert message from a networked computer;
generate a marquee text based at least in part on the first alert message; and
display the marquee text on the first window.

31. The apparatus of claim 25, wherein the processor is further configured to:
determine that a second screen is connected to the computing device; and
generate a second window based at least in part on a screen resolution or screen size of the for a second screen.

32. The apparatus of claim 31, wherein the processor is further configured to:
generate the first window or second window with a transparent background.

33. The apparatus of claim 25, wherein the processor is further configured to:
generate the first watermark with a vertical or horizontal orientation.

34. The apparatus of claim 25, wherein the processor is further configured to:
determine a process privilege or a data registry to prevent a user from terminating one or more modules.

35. The apparatus of claim 27, wherein the processor is further configured to:
cause to move the first watermark within the plurality of cells based at least in part on a predetermined time interval provided in a predetermined configuration.

36. The apparatus of claim 25, wherein the processor is further configured to:
determine that the first window is not a top-most window; and
cause to move the first window to the top-most window.

37. The apparatus of claim 25, wherein the processor is further configured to:
determine a time of a last activity is greater than a predetermined time; and
cause to move the first window to the top-most window.
